(19) United States
(12) Patent Application Publication
(10) Pub. No.: US 2019/0283369 A1
(43) Pub. Date: Sep. 19, 2019

(54) MONITOR GLASS PERIMETER COVER

(71) Applicant: B/E Aerospace, Inc., Winston-Salem, NC (US)

(72) Inventors: Jeff B. THOMPSON, Lewisville, NC (US); Bradley D. BARG, Advance, NC (US); Gregory J. SIMECEK, Winston Salem, NC (US)

(21) Appl. No.: 15/921,209

(22) Filed: Mar. 14, 2018

(51) Int. Cl. B32B 27/08; B32B 3/26; B32B 3/06; B32B 27/36; G06F 1/16

(52) U.S. Cl. CPC B32B 27/08; B32B 3/266; B32B 2457/20; B32B 27/365; G06F 1/1626; B32B 3/06

(57) ABSTRACT

A video monitor assembly including a video monitor having a film-covered glass screen, a perimeter cover affixed to the video monitor having a frame portion overlapping an outer perimeter of the front face of the glass screen continuously along the outer perimeter thereof, and a continuous seal provided between the frame portion of the perimeter cover and the overlapped portion of the front face of the glass screen to prevent glass fragment escape in a direction forward of the glass screen in the event of fracture of the glass screen.

### BACKGROUND

The present invention relates generally to preventing glass fragment escape from a shattered video monitor, and more particularly, to a monitor perimeter cover adapted to be affixed, bonded or otherwise attached to frame a glass monitor screen such that a continuous outer perimeter seal is provided between the monitor perimeter cover and the glass screen to prevent glass escape in one or more of forward and lateral directions away from the monitor screen.

Aircraft are commonly equipped with video monitors for displaying information and passenger use during flight. Video monitors can be mounted to seatbacks, partitions, class dividers, deploy from overhead, etc. Seatback monitors, to which the present invention finds particular application, are within striking distance of the head of a facing passenger in the event of rapid deceleration or other emergency event. As such, the glass screen of a video monitor aboard an aircraft is required to be covered with a protective film to prevent shattered glass from releasing from the monitor and coming into contact with a passenger or crew.

Regardless of the type of screen film applied, shattered glass fragments inevitably escape out through the sides of and ultimately forward of conventional video monitor assemblies. Therefore, to meet current aircraft crash test standards, what is needed is a containment solution that prevents any released glass fragments from escaping forward and/or laterally outward away from a video monitor.

### SUMMARY

To achieve the foregoing and other aspects and advantages, in one embodiment the inventive concepts disclosed herein are directed to a video monitor assembly including a video monitor including a glass screen having a film covering a front face of the glass screen, a perimeter cover affixed to the video monitor and having a frame portion overlapping an outer perimeter of the front face of the glass screen continuously along a top, a bottom, a left side, and a right side of the front face of the glass screen, and a continuous seal provided between the frame portion of the perimeter cover and the front face of the glass screen to prevent glass fragment escape in a direction forward of the glass screen.

In another aspect, the frame portion of the perimeter cover may be bonded to the film covering the front face of the glass screen.

In a further aspect, the frame portion of the perimeter cover may be adhesively bonded to the film covering the front face of the glass screen.

In a further aspect, the film may be a PET film or a polycarbonate film.

In a further aspect, the frame portion of the perimeter cover may overlap a minimum of 2.5 mm of the outer perimeter of the front face of the glass screen, measured from a lateral extent of an edge of the front face inward, along each of the top, the bottom, the left side, and the right side of the front face of the glass screen.

In a further aspect, the perimeter cover may overlap at least one of a top, a bottom, a left side, and a right side of the video monitor to prevent glass fragment escape in a lateral direction away from the video monitor.

In a further aspect, the video monitor includes a housing having at least one lateral tab having a hole for receiving a fastener therethrough for securing the video monitor assembly to a seatback.

In a further aspect, the perimeter cover includes at least one lateral tab having a hole for receiving a fastener therethrough for securing the perimeter cover to a seatback.

In a further aspect, the perimeter cover further includes at least one opening therethrough for accessing including bit not limited to at least one of a controller and an input jack of the video monitor.

In a further aspect, the perimeter cover may be thermoformed.

In another embodiment, the inventive concepts disclosed herein are directed to a monitor cover for an aircraft seatback monitor including a frame adapted to be bonded to a perimeter portion of a front face of a glass screen covered with a film, the frame overlapping an outer perimeter of the front face of the glass screen continuously along a top, a bottom, a left side, and a right side of the front face of the glass screen to prevent glass fragment escape in at least a direction forward of the glass screen.

In another embodiment, the inventive concepts disclosed herein are directed to a method for preventing glass fragment escape in a direction forward of a glass screen of an aircraft seatback video monitor, the method including the steps of providing a video monitor including a glass screen having a film covering a front face of the glass screen, providing a perimeter cover having a frame portion adapted to overlap an outer perimeter of the front face of the glass screen of the video monitor continuously along a top, a bottom, a left side, and a right side of the front face of the glass screen, and bonding the perimeter cover to the film to provide a continuous seal between the frame portion of the perimeter cover and the overlapped portion of the front face of the glass screen.

In a further aspect, the step of bonding includes adhesive bonding.

In a further aspect, the frame portion of the perimeter cover overlaps a minimum of 2.5 mm of the outer perimeter of the front face of the glass screen, measured from a lateral extent of an edge of the front face inward, along each of the top, the bottom, the left side, and the right side of the front face of the glass screen.

In a further aspect, the perimeter cover includes at least one lateral tab having a hole for receiving a fastener therethrough for securing the perimeter cover to a seatback.

### DESCRIPTION OF THE DRAWINGS

Features, aspects and advantages of the present invention are understood when the following detailed description of the invention is read with reference to the accompanying drawings, in which:

FIG. 1 is a front perspective view of a monitor cover according to a first embodiment;

FIG. 2 is a rear perspective view of the monitor cover of FIG. 1;

FIG. 3 is a top view of the monitor cover of FIG. 1;

FIG. 4 is a bottom view of the monitor cover of FIG. 1;

FIG. 5 is a front view of the monitor cover of FIG. 1;

FIG. 6 is a back view of the monitor cover of FIG. 1;

FIG. 7 is a top view of the monitor cover of FIG. 1;

FIG. 8 is a bottom view of the monitor cover of FIG. 1;

FIG. 9 is a cross-sectional view and detailed views of the monitor cover of FIG. 1 taken along line 9-9 of FIG. 5;

FIG. 10 is a front perspective view of a monitor cover according to a second embodiment;

FIG. 11 is a top perspective view of the monitor cover according to FIG. 10;

FIG. 12 is a bottom view of the monitor cover according to FIG. 10;

FIG. 13 is a top view of the monitor cover according to FIG. 10;

FIG. 14 is a front view of the monitor cover of FIG. 10;

FIG. 15 is a back view of the monitor cover of FIG. 10;

FIG. 16 is a right side view of the monitor cover of FIG. 10;

FIG. 17 is a eft side view of the monitor cover of FIG. 10;

FIG. 18 is a cross-sectional view and detailed views of the monitor cover of FIG. 10 taken along line 18-18 of FIG. 14; and

FIG. 19 is a perspective view of the monitor cover of FIG. 1 shown installed on a seatback shroud for an aircraft passenger seat.

### DETAILED DESCRIPTION

The inventive concepts disclosed herein are generally directed to a containment system for preventing glass fragments from a shattered glass screen of a video monitor from migrating or escaping at least forward of the video monitor. The containment system can further include side containment features for preventing glass fragment migration or escape in lateral directions away from the video monitor.

The containment system generally includes a perimeter cover that frames the glass screen while overlapping a predetermined minimum amount of a continuous portion around the outer perimeter of the front face of the glass screen, and while leaving uncovered the majority of the glass screen for unobstructed viewing. The perimeter cover is affixed directly to the glass screen or protective film, such as by bonding, adhesive, tape, etc., thereby providing a continuous outer perimeter seal on the front face between the film and perimeter cover such that any free glass fragment released from the glass screen is contained by the monitor cover.

The monitor cover can be installed by the original equipment manufacturer during video monitor manufacture, or can be applied thereafter to an existing video monitor. Suitable methods for affixing the monitor cover include, but are not limited to, bonding, glue, adhesive, tape, heat, etc. The external shape of the monitor cover may vary, for example for aesthetic reasons, while at least a portion of the frame and inner geometry of the cover may correspond to the shape of the underlying video monitor to provide a tight fit engagement therewith, at least with respect to the frame and the glass.

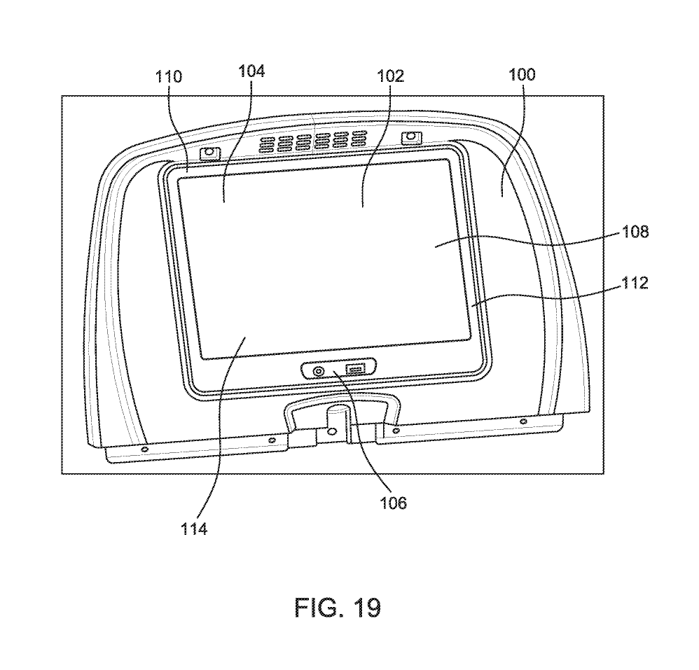

Referring now to the drawings, FIG. 19 illustrates a seatback shroud 100 configured to cover or close-out an upper portion of a seatback of an aircraft passenger seat. The shroud 100 may be made from molded plastic or other durable material. A video monitor 102 is shown generally centered with respect to the shroud 100. Centering the video monitor 102 relative to the upper seatback shroud 100 advantageously positions the video monitor 102 in an ideal and ergonomic viewing position for an aft-seated passenger, while disadvantageously positioning the video monitor 102 in a head strike area in the event of rapid deceleration.

The video monitor 102 generally includes a housing containing the electrical components, a glass screen 104, and a panel 106 containing controls and/or inputs. In a particular embodiment, the front face of the glass screen 104 is covered with a protective film 108, such as a PET or polycarbonate film for abrasion resistance and/or glass fragment retention.

A perimeter cover 110, also referred to herein as a “monitor cover” or “monitor perimeter cover,” is affixed to the video monitor 102, and particularly the perimeter cover 110 is affixed to at least a portion of the front face of the glass screen 104. The perimeter cover 110 may further be affixed to portions of the housing, or may tight-fit engage the housing. The perimeter cover 110 includes a frame portion 112 that overlaps an outer perimeter of the front face 114 of the glass screen 104 continuously along a top, a bottom, a left side, and a right side of the front face of the glass screen. As such, a continuous seal provided between the frame portion 112 of the perimeter cover 110 and the front face of the glass screen 104 to contain freed glass fragments, thus preventing glass fragment escape in at least a direction forward of the glass screen.

The frame portion 112 of the perimeter cover 110 may be bonded to the film 108 covering the front face 114 of the glass screen 104 such that glass fragment migration between the inner surface of the frame portion 112 and the film is prevented. In a particular embodiment, the frame portion 112 of the perimeter cover 110 overlaps a minimum of 2.5 mm all around the outer perimeter of the front face 114 of the glass screen 104, measured from a lateral extent of an edge of the front face inward, along each of the top, the bottom, the left side, and the right side of the front face of the glass screen. In addition to the front face 114, the perimeter cover 110 may overlap at least one of a top, a bottom, a left side, and a right side of the glass screen and video monitor to prevent glass fragment escape in lateral directions away from the video monitor, thus providing a comprehensive glass fragment containment system.

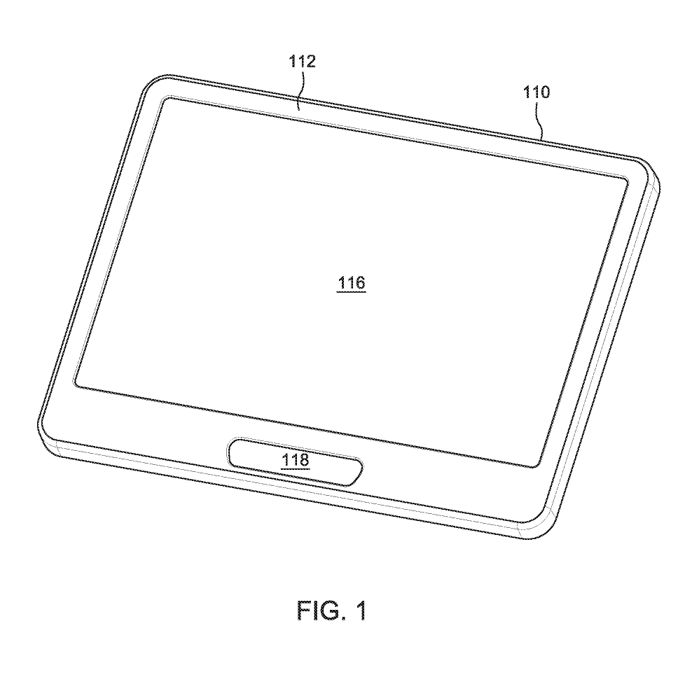

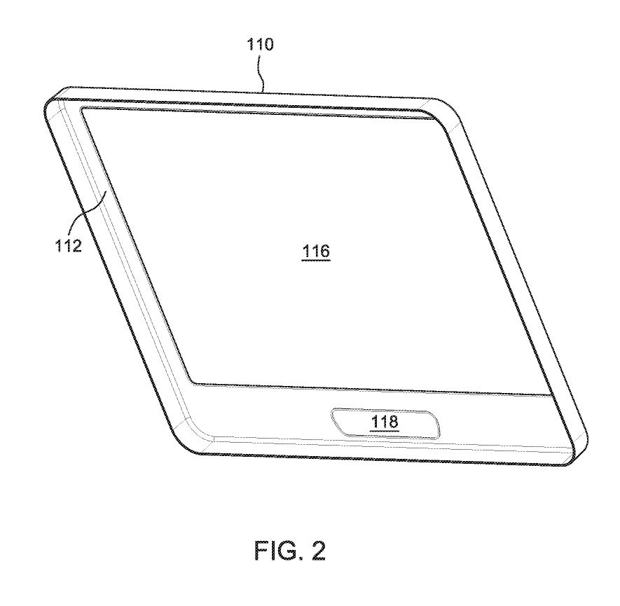

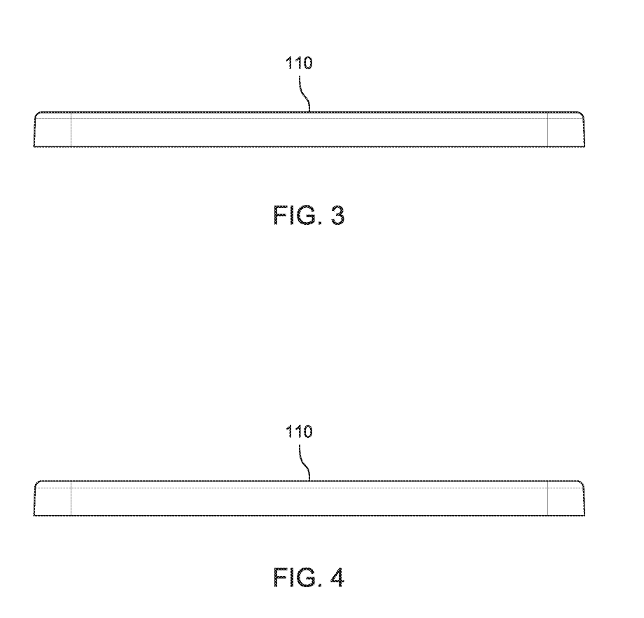

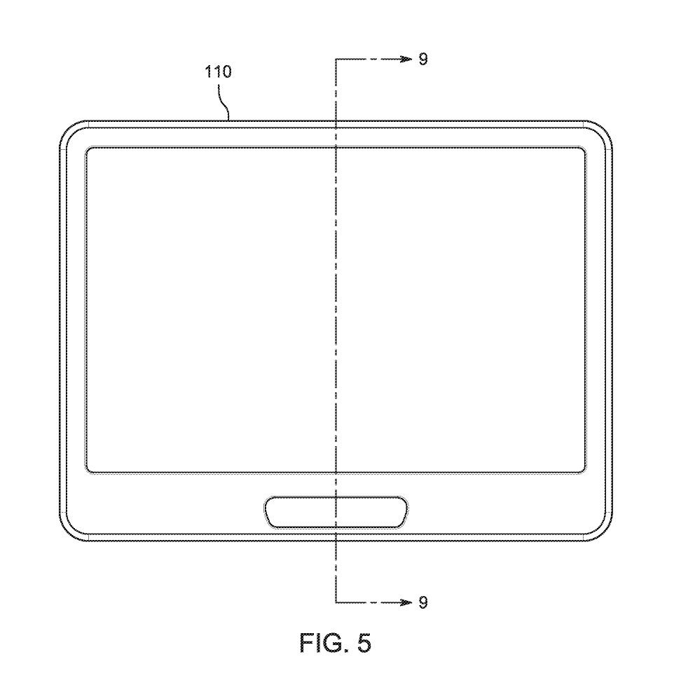

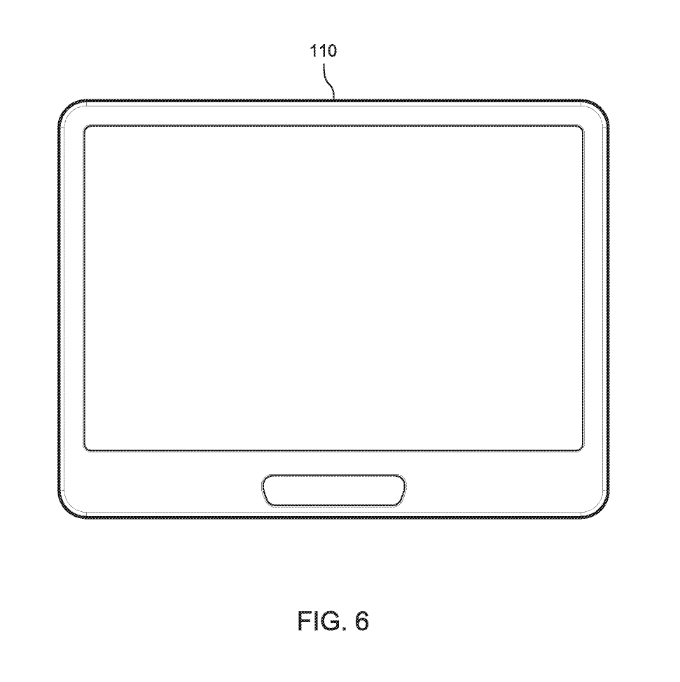

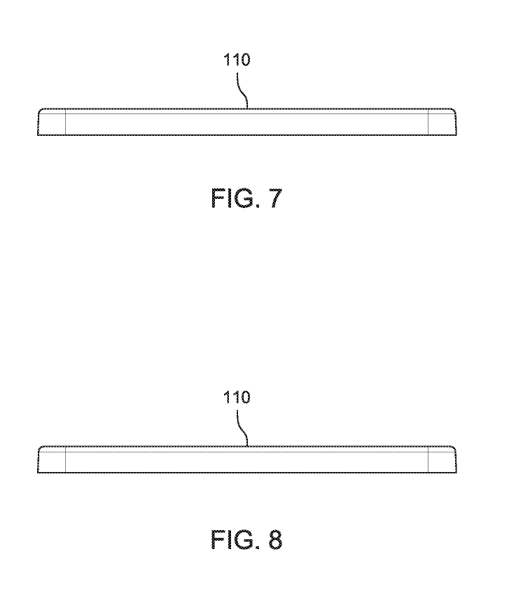

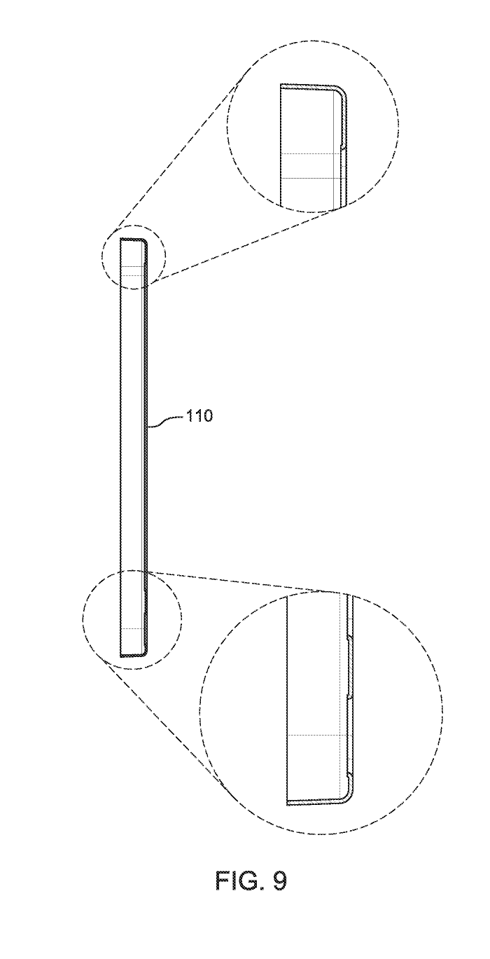

FIGS. 1-9 show various front, back, top, bottom, side and sectional views of the perimeter cover 110 shown installed in FIG. 19. The perimeter cover 110 shown includes include a first window 116 for viewing the viewable portion of the glass screen therethrough, and a second window 118 through which the panel 106 is accessed.

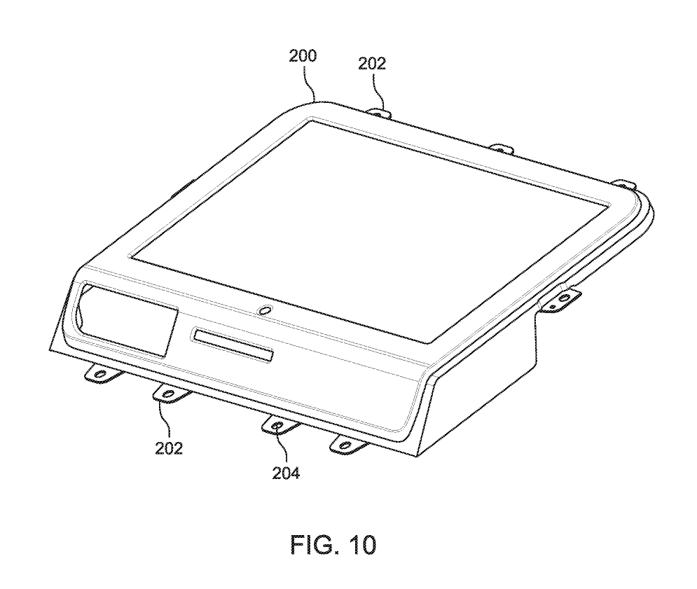

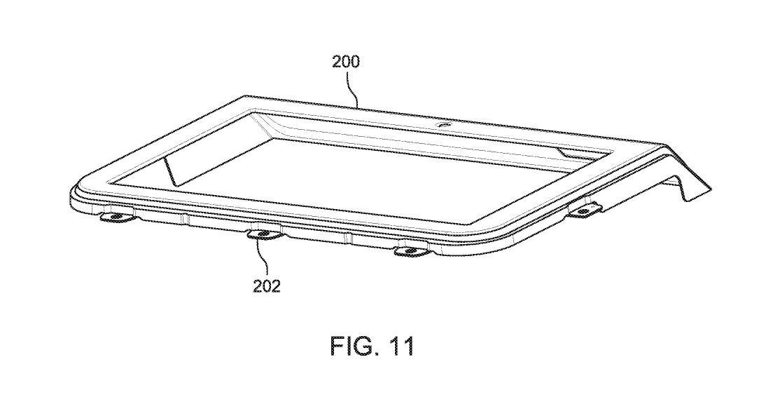

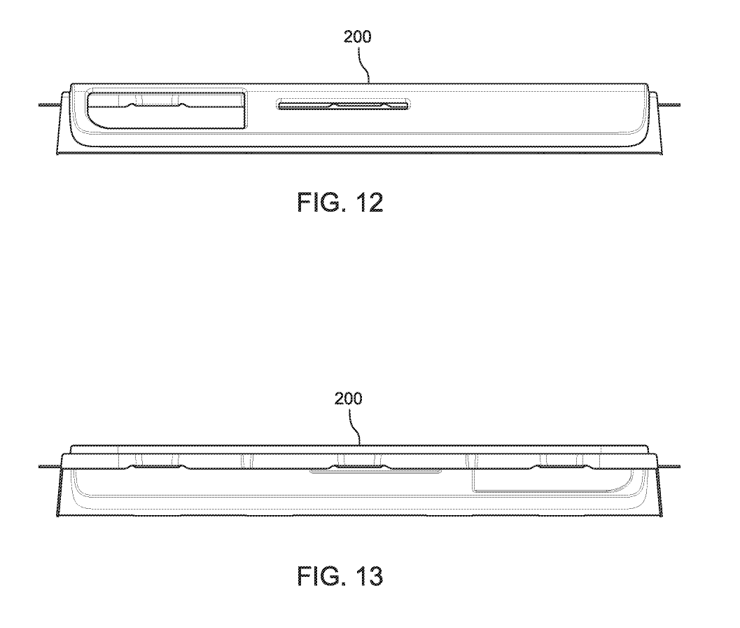

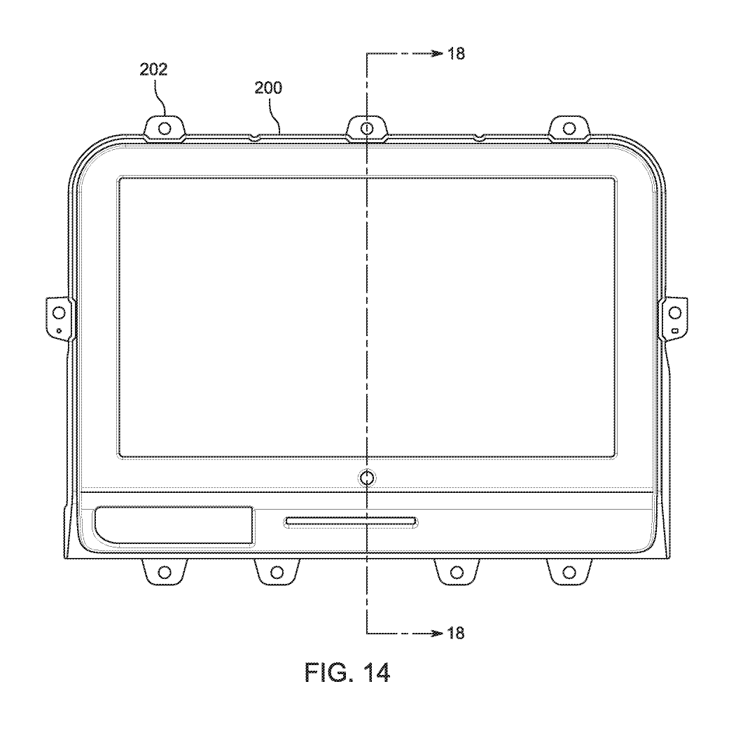

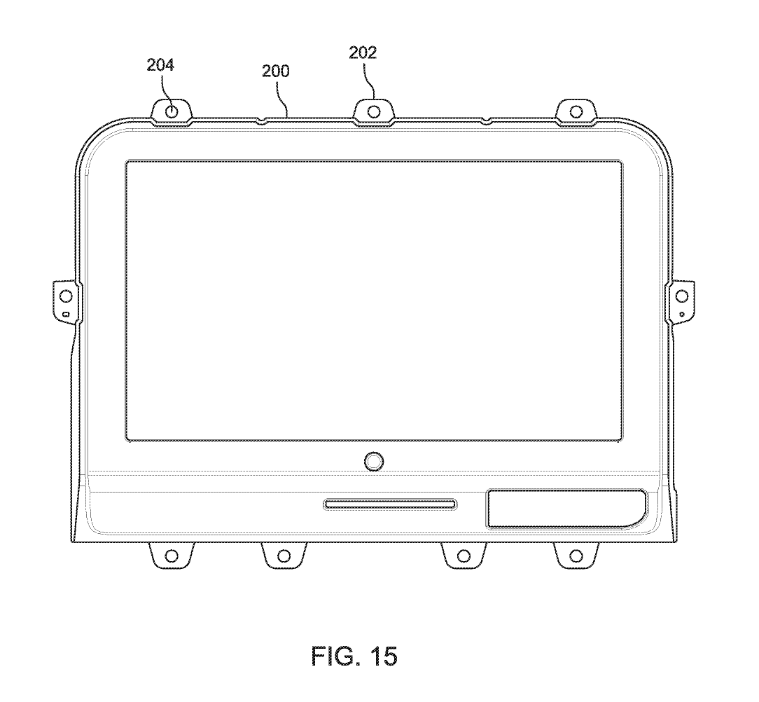

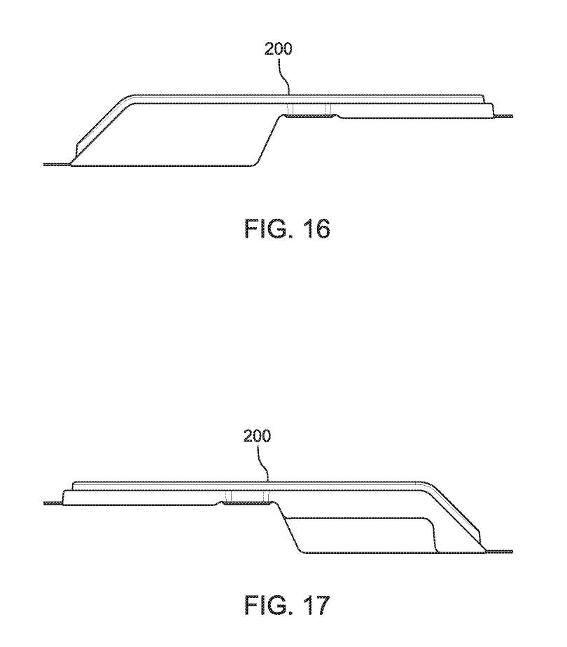

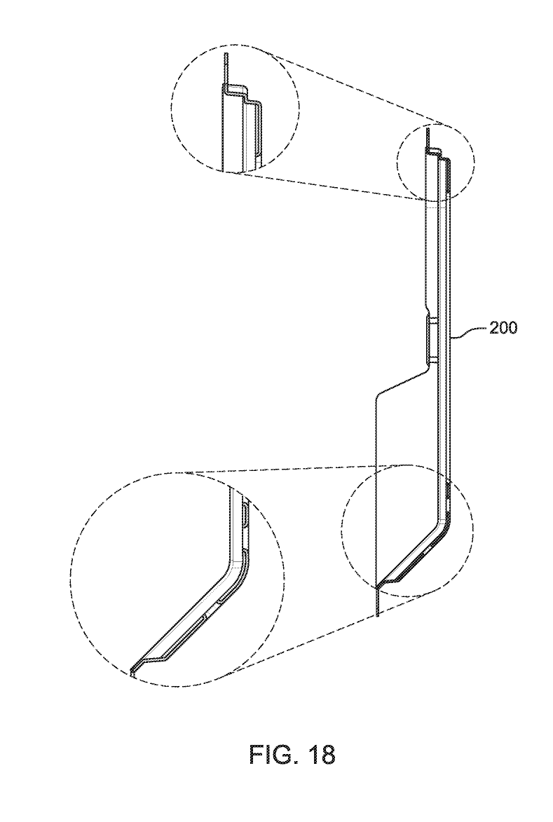

FIGS. 10-18 show various front, back, top, bottom, side and sectional views of a perimeter cover 200 according to a second embodiment. In comparison to the perimeter cover 110 according to the first embodiment, the perimeter cover 200 according to the second embodiment has a more complex shape and includes a plurality of lateral tabs 202 each having a hole 204 therethrough for receiving a fastener for securing the perimeter cover 200 to a seatback component, such as the seatback shroud or frame member. The lateral tabs 202 may serve to secure the perimeter cover 200 in place, serve to secure the perimeter cover 200 and video monitor in place, or align with like tabs of the video monitor such that a single fastener through each hole secures both the video monitor and perimeter cover in place.

The perimeter covers 110, 200 may be thermoformed or otherwise manufactured.

The inventive concepts disclosed herein are further directed to a method for preventing glass fragment escape in a direction forward of a glass screen of an aircraft seatback video monitor, including the steps of providing a video monitor having a glass screen having a film covering a front face of the glass screen, providing a perimeter cover having a frame portion adapted to overlap an outer perimeter of the front face of the glass screen of the video monitor continuously along a top, a bottom, a left side, and a right side of the front face of the glass screen, and bonding the perimeter cover to the film to provide a continuous seal between the frame portion of the perimeter cover and the overlapped portion of the front face of the glass screen.

Other embodiments and configurations may be devised without departing from the inventive concepts and scope of the appended claims.

What is claimed is:

1. A video monitor assembly, comprising:
a video monitor comprising a glass screen having a film covering a front face of the glass screen;
a perimeter cover affixed to the video monitor, the perimeter cover having a frame portion overlapping an outer perimeter of the front face of the glass screen continuously along a top, a bottom, a left side, and a right side of the front face of the glass screen; and
a continuous seal provided between the frame portion of the perimeter cover and the front face of the glass screen to prevent glass fragment escape in a direction forward of the glass screen.

2. The video monitor assembly of claim 1, wherein the frame portion of the perimeter cover is bonded to the film covering the front face of the glass screen.

3. The video monitor assembly of claim 1, wherein the frame portion of the perimeter cover is adhesively bonded to the film covering the front face of the glass screen.

4. The video monitor assembly of claim 1, wherein the film is a PET film or a polycarbonate film.

5. The video monitor assembly of claim 1, wherein the frame portion of the perimeter cover overlaps a minimum of 2.5 mm of the outer perimeter of the front face of the glass screen, measured from a lateral extent of an edge of the front face inward, along each of the top, the bottom, the left side, and the right side of the front face of the glass screen.

6. The video monitor assembly of claim 1, wherein the perimeter cover overlaps at least one of a top, a bottom, a left side, and a right side of the video monitor to prevent glass fragment escape in a lateral direction away from the video monitor.

7. The video monitor assembly of claim 1, wherein the video monitor comprises a housing having at least one lateral tab having a hole for receiving a fastener therethrough for securing the video monitor assembly to a seatback.

8. The video monitor assembly of claim 1, wherein the perimeter cover comprises at least one lateral tab having a hole for receiving a fastener therethrough for securing the perimeter cover to a seatback.

9. The video monitor assembly of claim 1, wherein the perimeter cover further comprises an opening therethrough for accessing at least one of a controller and an input jack of the video monitor.

10. The video monitor assembly of claim 1, wherein the perimeter cover is thermoformed.

11. A monitor cover for an aircraft seatback monitor comprising a frame adapted to be bonded to a perimeter portion of a front face of a glass screen covered with a film, the frame overlapping an outer perimeter of the front face of the glass screen continuously along a top, a bottom, a left side, and a right side of the front face of the glass screen to prevent glass fragment escape in at least a direction forward of the glass screen.

12. The monitor cover of claim 11, wherein the film is a PET film or a polycarbonate film.

13. The monitor cover of claim 11, wherein the frame is adapted to overlap less than 2.5 mm of the outer perimeter of the front face of the glass screen, measured from a lateral extent of an edge of the front face inward, along each of the top, the bottom, the left side, and the right side of the front face of the glass screen.

14. The monitor cover of claim 11, wherein the monitor cover is adapted to further overlap at least one of a top, a bottom, a left side, and a right side of the aircraft seatback monitor to prevent glass fragment escape in a lateral direction away from the aircraft seatback monitor.

15. The monitor cover of claim 11, further comprising at least one lateral tab having a hole for receiving a fastener therethrough for securing the monitor cover to a seatback of an aircraft passenger seat.

16. A method for preventing glass fragment escape in a direction forward of a glass screen of an aircraft seatback video monitor, comprising the steps of:
providing a video monitor comprising a glass screen having a film covering a front face of the glass screen;
providing a perimeter cover having a frame portion adapted to overlap an outer perimeter of the front face of the glass screen of the video monitor continuously along a top, a bottom, a left side, and a right side of the front face of the glass screen; and
bonding the perimeter cover to the film to provide a continuous seal between the frame portion of the perimeter cover and the overlapped portion of the front face of the glass screen.

17. The method of claim 16, wherein the step of bonding includes adhesive bonding.

18. The method of claim 16, wherein the frame portion of the perimeter cover overlaps less than 2.5 mm of the outer perimeter of the front face of the glass screen, measured from a lateral extent of an edge of the front face inward, along each of the top, the bottom, the left side, and the right side of the front face of the glass screen.

19. The method of claim 16, wherein the perimeter cover comprises at least one lateral tab having a hole for receiving a fastener therethrough for securing the perimeter cover to a seatback.

20. The method of claim 16, wherein the perimeter cover further comprises an opening therethrough for accessing at least one of a controller and an input jack of the video monitor.
